(19) United States
(12) Patent Application Publication
(10) Pub. No.: US 2026/0268337 A1
(43) Pub. Date: Sep. 10, 2026

(54) PROGRESSIVE VIRTUAL ASSISTANT FOR CREATING ARTIFICIAL INTELLIGENCE AGENTS

(71) Applicant: Vertex, Inc., King of Prussia, PA (US)

(72) Inventor: Christopher Zangrilli, Annville, PA (US)

(21) Appl. No.: 19/435,569

(22) Filed: Dec. 29, 2025

Related U.S. Application Data
(60) Provisional application No. 63/768,041, filed on Mar. 6, 2025.

(51) Int. Cl. G06Q 30/015; G06F 9/451; G06Q 40/12

(52) U.S. Cl. CPC G06Q 30/015; G06F 9/453; G06Q 40/123

(57) ABSTRACT

A computing system for creating an artificial intelligence agent on a tax platform includes processing circuitry that implements a tax application virtual assistant program. The processing circuitry is configured to receive a query related to a tax operation, identify an intent in the query to generate a new artificial intelligence (AI) agent, select a first workflow being configured to create a new workflow to be used in the generation of the new AI agent, instantiate, via a workflow orchestrator, utility agents to execute the first workflow and create the new workflow, and output the new workflow. The processing circuitry is further configured to select a second workflow configured to generate the new AI agent based on the new workflow, instantiate, via the workflow orchestrator, utility agents to execute the second workflow and generate the new AI agent, and output the new AI agent.

### CROSS REFERENCE TO RELATED APPLICATIONS

The present application is based upon and claims priority under 35 U.S.C. 119 (e) to U.S. Provisional Patent Application Ser. No. 63/768,041 filed Mar. 6, 2025, the entirety of which is hereby incorporated herein by reference for all purposes.

### BACKGROUND

In the modern tax information ecosystem, global businesses that sell goods and services in a variety of countries and localities, either online or via physical stores, typically configure their point of sale and/or enterprise resource management computing systems to engage with enterprise tax technology provider platforms that automate and digitize preparation of tax returns and filings to the various local tax authorities, thereby ensuring global compliance with tax laws. These same businesses typically retain multinational legal and accounting firms to give them professional advice regarding how to set up their corporations, prepare and file their corporate tax returns, respond to audits, and generally comply with local tax laws in each jurisdiction. Information in each of the legal and accounting firms and the tax technology provider platforms tends to become siloed, since technical challenges for information exchange exist.

Language models have been developed that can be leveraged to provide users with a natural language interface for answering questions. To expand the functionality of language models, agentic machine learning systems have been proposed that respond to a user's query received via a language model chat interface, by employing one or more language model agents configured perform certain specialized tasks defined in a workflow. To date, the application of such language models and agentic systems to tax technology has been limited.

### SUMMARY

To address these issues and others described herein, systems and methods for creating artificial intelligence agents on a tax platform are disclosed herein. According to one aspect, a computing system for creating an artificial intelligence agent is provided. The computing system includes a computing device including processing circuitry configured to execute instructions using portions of associated memory to implement a tax application virtual assistant program. The processing circuitry is configured to receive a query related to a tax operation via a chat interface in a turn-based dialog session, identify an intent in the query to generate a new artificial intelligence (AI) agent, and implement a workflow selector to select a first workflow from a plurality of workflows in a workflow library. The first workflow is configured to create a new workflow to be used in the generation of the new AI agent. The processing circuitry is further configured to instantiate, via a workflow orchestrator, one or more utility agents to execute the first workflow and create the new workflow, and output the new workflow to the workflow library. The processing circuitry may be further configured to implement the workflow selector to select a second workflow from the plurality of workflows in the workflow library. The second workflow is configured to generate the new AI agent based on the new workflow. The processing circuitry is further configured to instantiate, via the workflow orchestrator, one or more utility agents to execute the second workflow and generate the new AI agent, and output the new AI agent.

According to another aspect, a method for creating an artificial intelligence agent is provided. The method includes receiving a query related to a tax operation via a chat interface in a turn-based dialog session, identifying an intent in the query to generate a new artificial intelligence (AI) agent, and selecting a first workflow from a plurality of workflows in a workflow library. The first workflow is configured to create a new workflow to be used in the generation of the new AI agent. The method further includes executing the first workflow to create the new workflow, and outputting the new workflow to the workflow library. The method further includes selecting a second workflow from the plurality of workflows in the workflow library. The second workflow is configured to generate the new AI agent based on the new workflow. The method further includes executing the second workflow to generate the new AI agent, and outputting the new AI agent.

According to another aspect, a computing system for creating an artificial intelligence agent is provided. The computing system includes a computing device including processing circuitry configured to execute instructions using portions of associated memory to implement a tax application virtual assistant program. The processing circuitry is configured to receive a query related to a tax operation via a chat interface in a turn-based dialog session, identify an intent in the query to generate a new artificial intelligence (AI) agent, and implement a workflow selector to select a first workflow from a plurality of workflows in a workflow library. The first workflow is configured to create a new workflow to be used in the generation of the new AI agent. The processing circuitry is further configured to instantiate, via a workflow orchestrator, one or more utility agents to execute the first workflow and create the new workflow, display the new workflow as a sequence of steps in a graphical user interface for human-in-the-loop review, and output the new workflow to the workflow library. The processing circuitry may be further configured to implement the workflow selector to select a second workflow from the plurality of workflows in the workflow library. The second workflow is configured to generate the new AI agent based on the new workflow. The processing circuitry is further configured to instantiate, via the workflow orchestrator, one or more utility agents to execute the second workflow and generate the new AI agent, and output the new AI agent. After being output, the new AI agent is included in a tax-related AI agent marketplace on the tax platform for use by customers and third parties.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic view of a computing system for creating an artificial intelligence agent, according to an example implementation.

FIG. 2 shows a schematic diagram of a utility agent library and data sources for creating the artificial intelligence agent, in accordance with the computing system of FIG. 1.

FIG. 3 shows a flowchart for creating and generating the artificial intelligence agent, in accordance with the computing system of FIG. 1.

FIG. 4 shows a schematic diagram of a chat interface and workflow orchestrator for creating the artificial intelligence agent, in accordance with the computing system of FIG. 1.

FIG. 5 shows a flowchart for a method for creating an artificial intelligence agent, according to an example implementation.

FIG. 6 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods or to perform activities. Tax applications can help users manage clients and handle the complexities of determining tax rates for different products, as well as for different vendors and locations. However, using a “one-size-fits-all” approach for these tasks can be inefficient and error-prone.

The embodiments described herein relate to implementing a progressive virtual assistant (i.e., “Copilot”), which includes a turn-based conversational interface that can be deployed across various cloud applications. The virtual assistant may embody different interfaces and tools, including those required for creating and generating customizable tax platform artificial intelligence agents. The artificial intelligence agents may be configured for specific tax-related data retrieval and task automation functions, such as accessing data, configuring data, determining taxes, generating reports, and the like, and workflows associated with each agent may be modified prior to or after implementation of the respective agent.

While the embodiments disclosed herein are described in the context of a tax application, the concept of context-aware virtual assistance may be implemented in any suitable type of application, such as applications for communication, entertainment, productivity, education, security, and finance.

It will be appreciated that the example implementations described herein and with reference to the figures are exemplary in nature and are thus not intended to limit the scope of the disclosure, as numerous variations of the provided implementations are possible.

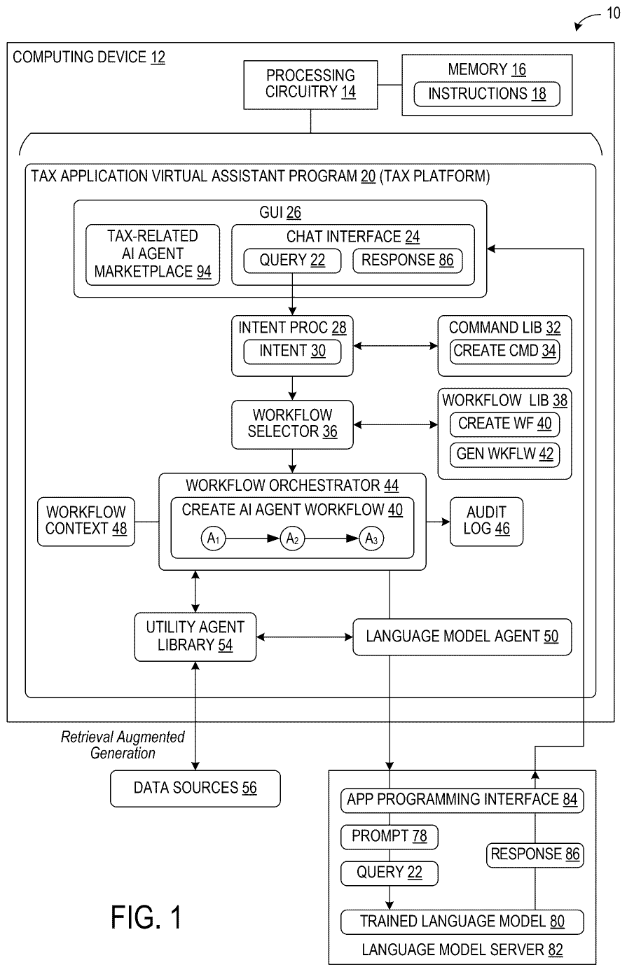

To address the issues described above, a computing system for creating an artificial intelligence agent is provided. As shown in FIG. 1, the computing system 10 includes a computing device 12 with processing circuitry 14 and associated memory 16. The memory 16 stores instructions 18 that cause the processing circuitry 14 to execute a virtual assistant program, such as a tax application virtual assistant program 20. It will be appreciated that distributed processing strategies may be implemented to execute the tax application virtual assistant program 20 described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. It will additionally be appreciated that the computing device 12 may be implemented as a client device, or as a server device in communication with a client device.

The tax application virtual assistant program 20 (i.e., virtual assistant) is implemented to interface with a generative model, such as a trained large language model (LLM) 82, small language model (SLM), etc. For example, a generative pre-trained transformer model, such as Chat-GPT 4o, LLaMA, etc., can be used. In some examples, the model can be a multi-modal model configured to accept text, images, and/or audio as forms of input and configured to generate text, images, and/or audio as output.

Upon executing the tax application virtual assistant program 20 in an inference phase, the processing circuitry 14 is configured to receive a query 22, which may be input during a turn-based dialog session between a user and the tax application virtual assistant program 20 via a chat interface 24 displayed in a graphical user interface (GUI) 26 of the computing device 12. The user may be a customer or client using a tax application, and the query 22 may be a request to perform a tax-related task, which requires the creation of an artificial intelligence (AI) agent, or a command to create the AI agent to perform the tax-related task, for example. In response to the query 22, an intent processor 28 may be implemented to process the query 22 and identify an intent 30 of the user based on information in the query 22. The intent processor 28 selects a command associated with the identified intent 30 from a command library 32. One of the command types that will be discussed below is the create agent command 34, which is called when the user intent 30 is detected as desiring or requiring to create a new AI agent on the tax platform. It will be appreciated that the command library and other libraries described herein, such as the workflow library and utility agent library, may be configured as databases.

Based on the selected command, the workflow selector 36 selects a workflow from a plurality of workflows stored in a workflow library 38. Two stored workflows that will be discussed below are the create agent workflow 40 and generate agent workflow 42. The first workflow is a create agent workflow 40 that, when executed, creates a new workflow that is used in the generation of a new AI agent on the tax platform, and the second workflow is a generate agent workflow 42 that, when executed, generates the new AI agent from the new workflow.

The create agent workflow 40 is passed to a workflow orchestrator 44, which in turn calls the appropriate agents to implement the create agent workflow 40. The create agent workflow 40 may be configurated as a directed acyclic graph including a plurality of nodes, which are represented in FIG. 1 as A₁, A₂, A₃. For each node the workflow, the workflow orchestrator 44 typically instantiates one or more agents to accomplish a subtask, and passes a computation result to a next node in the directed acyclic graph. In a simplest implementation, the workflow is a linear series of nodes that represent steps in the workflow. Thus, the workflow orchestrator 44 is configured to instantiate one or more agents, such as a language model agent 50 and utility agents 52 to perform tasks over a series of successive nodes in the create agent workflow 40.

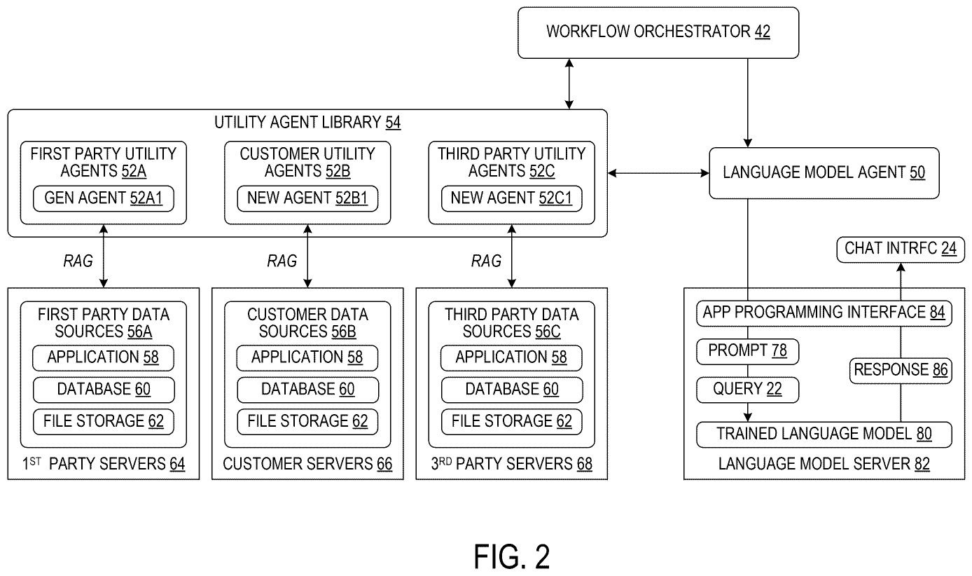

With reference to FIG. 2, the utility agents 52 are selected from a utility agent library 54, and may include first party utility agents 52A, customer utility agents 52B, and third party utility agents 52C, for example. Utility agents 52A, 52B, 52C have skills and logic that enable them to access data sources 56A, 56B, 56C, perform operations on the data at each node, and pass the result to a subsequent node. In particular, the utility agents 52A, 52B, 52C are configured to access tax data and tax logic at a tax database 58, application 60, or file storage 62 at each data source 56. The data sources can include first party data sources 56A executed on first party servers 64, customer data sources 56B executed on customer servers 66, and/or third party data sources 56C executed on third party servers 68.

Returning to FIG. 1, actions performed during execution of the create agent workflow 40 are logged by the workflow orchestrator 44 in an audit log 46. Further, context from interactions with the language model agent 50 and utility agents 52A, 52B, 52C at each node can be stored as workflow context 48, which is passed with read write privileges to each successive node in the create agent workflow 40. In this way, state can be maintained and communicated among the agents involved in the create agent workflow 40.

The create agent workflow 40 enables a customer or third party to create new workflows using utility agents 52 and a simple logic editor, and the new workflows may be included in the workflow library. The generate agent workflow 42 allows customers or third parties to instantiate a generate agent 52A1 included in the first party utility agents 52A to define new customer agents 52B1 or new third party agents 52C1 based on the new workflows. A permissions system can be provided for customers and third parties to restrict access to the workflow library 38 and utility agent library 54 to authorized users to prevent accidental changes and to protect proprietary information. For example, the customers or third parties can use the permissions system to restrict access to a set of authorized users including (1) the third party's own employees, (2) customers that are clients of the third party, (3) one or more specified customers of the platform, and/or (4) all customers of the platform. Alternatively, the permissions level may be set to allow any user having access to the platform to use agents.

As illustrated in FIGS. 1 and 2, information collected, processed, and output from the utility agents 52 can be passed via language model agent 50 along with the query 22 from the user and a prompt 78 to a trained language model 80 executed on a language model server 82. The prompt 78 can be engineered to include all or part of the workflow context 48 and a language model instruction (e.g., “Answer the query in view of the following context.”). This input data is typically sent via a language model application programming interface (API) 84, and causes the trained language model 80 to generate a response 86 to the query 22. Once the response 86 is generated, it is sent back from the language model server 82 to the chat interface 24 for display to the user. The response can include, for example, a confirmation that the new workflow has been created and/or that the new agent has been generated.

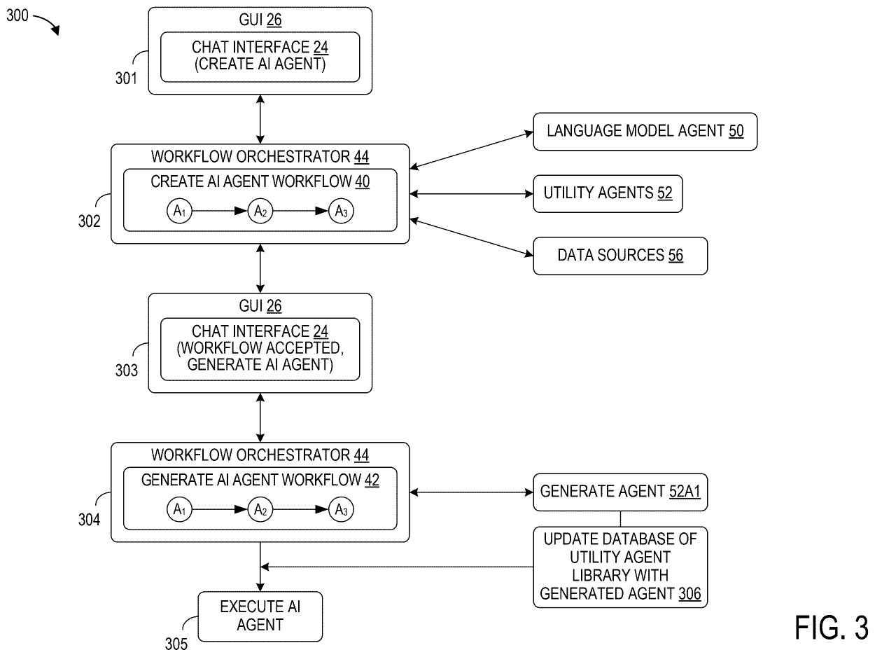

FIG. 3 shows a flowchart 300 for creating and generating a new AI agent. As illustrated at 301, a user query including an intent to create an AI agent is entered in the chat interface 24. At 302, the workflow orchestrator 44 instantiates the language model agent 50 and utility agents 52 to execute the create agent workflow 40 using data sources 56 to create a workflow for the new AI agent. The new workflow may be displayed in the chat interface 24, where it can be reviewed and modified by the user. As indicated at 303, the new workflow may be accepted, and a command to generate a new AI agent based on the new workflow may be entered. The workflow orchestrator 44 then retrieves the generate agent workflow 42 and calls the generate agent 52A1 from the first party utility agents to execute the generate agent workflow 42, as shown at 304. As shown at 305, the utility agent library 54 is updated to include the new AI agent, which may a new customer AI agent 52B1 or a new third party AI agent 52C1, as described above. Upon generation of the new AI agent and storage in the utility agent library 54, the system 10 may be configured to execute the new AI agent immediately or schedule the new AI agent to run at specific times or under specific conditions, as shown at 306. The execution can be under the command of the user that created the newly generated agent 52A1, or a subsequent user with sufficient permissions to access the newly generated agent 52A1 in the utility agent library 54.

The new workflows can include nodes that instantiate the new agents 52B1, 52C1. The new agents 52B1, 52C1, like any utility agent 52A, 52B, 52C, can be configured to interrogate a specified data object located on one of the data sources 56. The third party creating the new agent 52C1 can specify appropriate permission to enable the new agent to interact with a data object hosted at the third party data source 56C. The new agent 52C1 can be configured to analyze the interrogated data object and generating output from the analysis. By way of example, the data object may be contained in a tax determination, compliance, or e-invoicing database 60, which is configured and can be used to generate data on the platform. The new agent 52C1 can be configured to access customer specific private data, or platform hosted non-private data such as datasets in a tax rate and rule database, a taxability database, or a forms database, for example. Third parties and their customers can also configure the new agent 52C1 to interact with customer-private data such as e-invoicing data (customer data generated with a third party vendor) or a chart of accounts (customer private data), for example. The new agent 52C1 can be configured to generate a report over these such sources. The new agent can be provisioned with programming logic to perform certain actions on this data. In one specific example, the new agent 52C1 can be configured to perform analysis in the form of reconciliation and tax sensitization on a generated report for a specified period of time, such as a given month. Using the present system, agentic logic such as this could be packaged into an agent by a third party, such as an accounting firm, and offered to other companies, such as other customers of the accounting firm.

In this way, an ecosystem can be created for tax-related AI agents that operate on an enterprise tax technology provider platform. Customers and other third parties can create tax-related AI agents using the create agent workflow 40 and the generate agent workflow 42, and offer new workflows and new AI agents to customers via a tax-related AI agent marketplace 94 displayed in the GUI 26

For data sources 56, the following example data sources can be used: customer data, tax determination configuration data, tax determination generated data (transactions), compliance configuration data, compliance generated data (returns), e-Invoicing configuration data, e-invoicing generated data (transactions), first party/non-private data, rate & rule database, taxability database, and forms database.

For programming logic included at each node in workflows 40, 42, the following example actions can be used: scheduling, generate report (with report filter), export/output formatting, analyze logic, summarize using generative AI, notifications, and human-in-the-loop (HITL).

For programming logic included at each node in workflows 40, 42, the following example execution attributes can be used: execution mode (interactive, autonomous) and HITL target (first party, customer, third party).

For the workflows 40, 42, the following example workflow characteristics can be adopted, in one implementation:
1. Workflows define a sequential ordering of actions accomplished by program logic with the possible aid of utility agents or language model agents
2. Each action is treated as a step in a workflow, with each execution step logged to an audit log, and the result of each execution step passed to the next execution step, the steps corresponding to nodes in a directed acyclic graph.
3. The number of steps (or nodes) in the workflow can be limited to a predetermined number to establish a limit on the computational burden of each workflow. The limit, may, for example, be 10 steps.

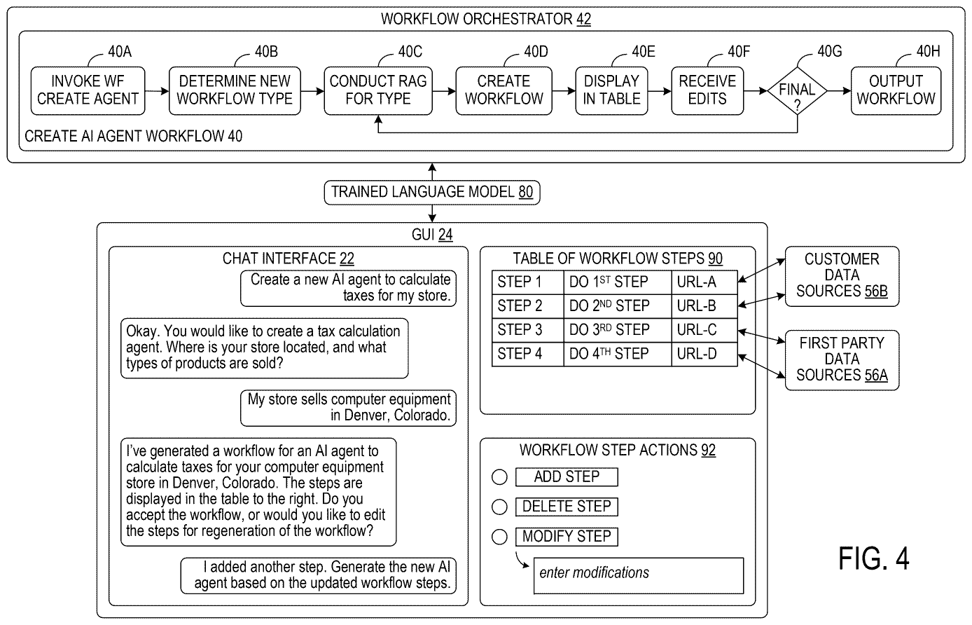

Thus, it will be appreciated that workflows are a set of sequential actions that form the steps of a workflow. Workflows are created by providing a description of the work to be done by the AI agent into a conversational interface, such as the chat interface 24 discussed above. The description is interpreted by a generative language model, such as the trained language model 80, to understand the intent, clarify unknowns, and then represent a draft sequence of actions on the screen in a table view, as shown in FIG. 4.

FIG. 4 illustrates the workflow orchestrator of FIG. 1 implementing the create agent workflow 40. According to this workflow, an agent is invoked at 40A that is configured to determine the new workflow type at 40B. The workflow orchestrator 42 then selects a retrieval augmented generation (RAG) prompt template and prompts the language model agent 50 to conduct RAG for the determined workflow type at 40C. The language model agent 50 engages in a conservation via the chat interface 22 with the user in an attempt to identify blank information in the RAG prompt template. Once sufficient information has been elicited to generate a workflow for creating the new AI agent, the workflow orchestrator 42 prompts the language model agent 50 to create the new workflow at 40D. As shown in FIG. 4, an example new workflow is displayed as a sequence of steps in a table 90 at 40E, with the table 90 and the chat interface 22 being displayed in the GUI 26 for human-in-the-loop review. The GUI 26 can be configured to enable the user to edit the sequence of steps in the new workflow shown in the table 90 by moving actions, removing actions, editing actions, and adding actions in the sequence, through click and drag or copy and paste actions on the table. Additionally or alternatively, modification to the workflow steps in the table 90 may be initiated in a separate panel 92, for example. As shown, each action includes a step identifier, an action description, and a URL for a data source used by the action. The URLs may point to any of data sources 56. In the illustrated example, the URLs point to customer data sources 56B and first party data sources 56A. Once any edits to the workflow steps 90 are received at 40F, the user is asked at 40G via the chat interface 22 to confirm whether the workflow is final, or whether additional revisions should be made. For additional revisions, the workflow returns to 40C to conduct further RAG. If user input confirms the workflow is final, the new workflow is output at 40H.

Example analysis logic and actions that can be included in each node in the new workflow are discussed below.

### Analyze Logic Action

The Analyze Logic action is a specially defined action that can be applied to an intermediate output or a report/export. The logic is a set of generative language model prompts and context that can be passed into an LLM to perform analysis of tax report data, by incorporating tax specific instructions. The first party data sources 56A include a library of Analyze Logic actions for users and will license the ability for customers or third party partners to add to that library. This logic is programmed to perform tax analysis of the reports to identify anomalies, patterns, and answer tax questions.

It will be appreciated that some nodes in the new workflow may define HITL actions. Examples are discussed below.

### Human-In-the-Loop (HITL) Action

The HITL action is a specially defined action that creates an interactive session to have a human review and human action. The HITL action has two modes-interactive and review. The interactive mode pauses the workflow of the tax agent until the session is completed, and the review mode occurs as the last step in a workflow, and will end the workflow once the session is started. In both modes a web screen is exposed to a user that will allow for download and review of the output from the previous step in the workflow. In the interactive mode, a set of HITL actions that can be taken may be displayed and selectable, such as continue with no change, continue with changed document, or continue with an additional document.

The HITL screen can also be governed by the execution attributes, which can specify that the human interactive session is provided to the customer, a third party, or the first party. Access to this screen can be further defined by roll-based access, which may identify which users can access the HITL screen, and, in the case of a partner or the first party, also include a list of customers for which a user can process HITL.

### Tax Agent Marketplace

Each AI agent on the tax platform has a unique name and the option of being visible to the users from one company or published into a marketplace. To this end, the computing system 10 is configured to display a tax-related AI agent marketplace 94 in the GUI 26 to enable users to browse agents and workflows that have been created by customers and third parties. The marketplace of tax-related AI agents will enable an ecosystem on the first party platform that can allow first party members, customers, and third parties to co-create new AI agents and make them available for the community to use. The marketplace is configured to track usage and enable other parts of the system to trigger recommendations to users. While the AI agent can be exposed in the marketplace, its execution can be limited by the entitlements that an account has and may perform differently from one account to another due to the different data sets/data objects that an account may have.

The GUI 26 may take various forms, and have various modes of interaction, as follows.

### User Experience (UX)

In one example, the GUI 26 can have three modes of interaction, as follows.
1. Agent Creation Mode
2. Marketplace Mode
3. Interactive Execution Mode

Each of these modes is tailored for a specific workflow, with the first being tailored for the create agent workflow, the second being tailored for a workflow in which a user selects an agent and/or workflow to use, and the third a mode in which the user is implementing a selected workflow. The agents can be created for use in the field of indirect tax reporting, or for use in other indirect tax processes.

### Agent Creation Mode

In this mode, the user may be presented with a conversational interface, such as the chat interface 24 in the GUI 26, that prompts the user for a variety of inputs such as name, actions, data sources, and any AI processing, in RAG style using the RAG template discussed above. The language model agent processes these inputs 50 using the trained language model 80 to understand the intent and develop a plan of execution steps or actions. The steps or actions are displayed in a table on the screen, such as the table 90 discussed above. The user has the ability to modify the steps through the chat interface 22 or by directly modifying the tables, with modifications on the actions or order of activities, through copy and paste, click and drag, or directly typing into the table, for example, as briefly mentioned above. Agents can be confirmed to perform actions such as setting report criteria, running reports, translating output formants, summarizing reports, performing AI analysis of reports, and time/day scheduling. Other actions are also contemplated.

After the workflow of an agent is agreed to by the user (e.g., at 40G discussed above), it can be saved into a package with a name. According to a default setting, this package is only available to users of the account under which it was created. However, there is an option selectable by the user to make the package available in a marketplace for users of other accounts (e.g., other customers or other third parties) to access. This agent package can have permissions associated with it, as read-only in the account, and can have access to the data objects and actions that are enabled by license entitlement in each user's account that uses the package.

### Interactive Mode

In the Interactive Mode, agents and workflows included in packages that have been generated and stored in the above-described manner can be executed for testing. After testing is complete, the agent can be marked for autonomous execution, which triggers the agent to execute based upon user-specified conditions that are bound to the package, such as schedule conditions (e.g., once a month).

An enhanced GUI 26 may be provided to manage the Analyze Logic action. This exposes a library of first party Analyze logic and approved customer and/or partner logic. Each logic segment is named and described, with the support for searching. Upon having an additional license entitlement, the user will be able to create Analyze Logic. Analyze Logic is included in a package having a name, description, prompt, meta-prompt, and additional context that is either a place holder to point to an intermediate file or static context. The context is saved in a first party database, while the other pieces are stored in a first party relational database. The system 10 can execute the workflows with a combination of human-in-the-loop and automated analysis of the Analyze Logic to help govern proper use and stop inappropriate logic.

### Marketplace Mode

In this mode, the GUI 26 is configured to display available tax agents and workflows and enables a user to browse and select agents and workflows to be used in the user's account. The workflows and agents are organized by a grouping category to allow for browsing or searching by name or creator. The use of any agents selected in the marketplace is tracked, with usage metrics available to be published. In some versions, the workflows and agents are packaged together as an “agent.” That is, a workflow that actually calls one or more language model agents and utility agents to perform an operation can be offered as an “agent” in this embodiment of the system. Once a tax-related AI agent is selected, the agent task plan (i.e., workflow steps) is displayed, and the GUI 26 enables the user to customize the task plan by changing any input parameters as desired. While the input parameters are customizable to point to customer data, for example, the steps and order of the plan typically are not editable in the Marketplace Mode. This parameter avoids unintentional or unwanted changes such that the tax-related AI agents on offer perform as their creators intended. Upon saving the updated agent package to the account, it can be run in interactive execution mode or autonomously.

### Interactive Execution Mode

The GUI 26 may also be configured to implement an Interactive Execution Mode. This mode allows the user to run a tax-related AI agent and associated workflow interactively, which includes seeing the execution steps and being able to view the final output. The Interactive Execution Mode bypasses any scheduling steps that may be saved for a workflow and executes the workflow immediately. Each step is displayed in the GUI 26 as it is performed and may include a check mark for a completed step, and a warning sign or a stop sign for an errant step. In the event of a warning or an error, the user will be able to view a message from the system 10. Upon successful completion of the task plan defined in the workflow, a URL will be provided to the user to view or download the final output, which can, for example, be a report or export of tax data. The audit log 46 of the execution steps will also be available to view. In the Interactive Execution Mode, a start page can be displayed in the GUI 26 that includes links to execute all of the tax-related AI agents that are enabled for an account. The agents and workflows may be organized by name, creator, or category, for example. The start page also provides a search capability.

Each of the Interactive Mode, Marketplace Mode and Interactive Execution Mode are configured to run in the cloud on first party servers 64 and use a REACT® technology stack for the GUI 26. The tasks are serialized into a data object that is stored in a database for future retrieval. Underlying the execution of the user created agent is a collection of utility agents and an orchestration agent, as described above. Typically, one utility agent is provided for each action category. The workflow orchestrator 44 loads the user defined workflow, and interrogates the scheduling and permissions to determine whether it should run the workflow. If it is determined that the workflow should be executed, the workflow orchestrator 44 uses the agent workflow to determine which utility agents to call and passes in the saved information. If Analyze Logic is part of the execution plan, a utility agent passes the intermediate file(s) and Analyze Logic package to an LLM for processing. The output from each step is stored on a file system that is permissioned for the user account. This area on the file system is used by the workflow orchestrator 44 and the utility agents to complete the workflow and provide a link to the end output to the user. The link can be emailed to the user or displayed in the GUI 26. Each execution of the agent workflow is versioned, and the audit log 46 captures all steps taken.

### First Party Utility Agents

Each action in a workflow is implemented through a utility agent. Each of these utility agents has an exposed API that is serviced by an autonomous service to develop a plan of action based on the input of the API, execute the plan by calling APIs across the cloud platform of the first party server 64, retrieve any additional input needed, and store results to a file system. This functionality is performed with application security restricted to the customer's account and will log a record of actions and errors.

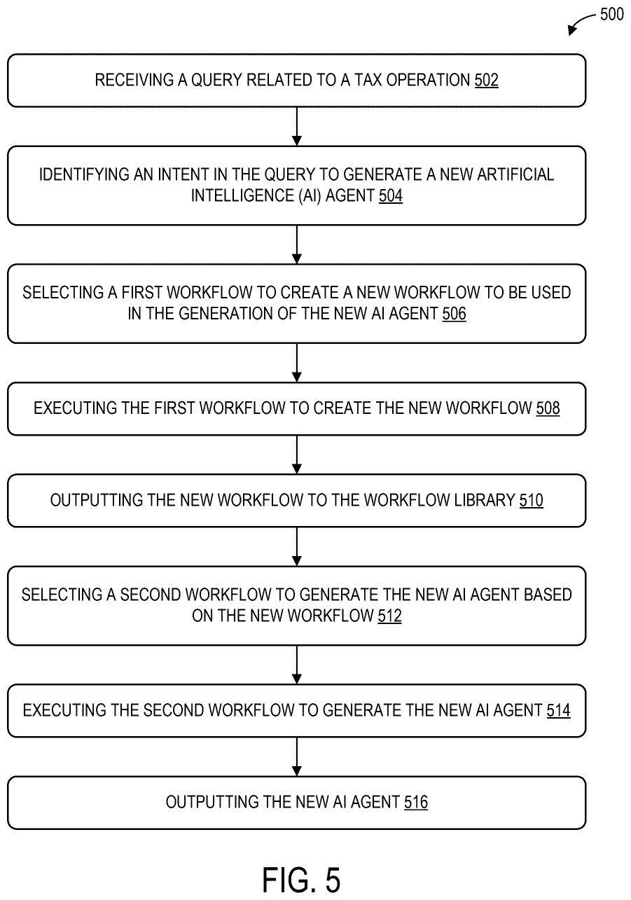

FIG. 5 shows a flowchart for a method 500 for creating an artificial intelligence agent. The method 500 may be implemented by the computing system 10 illustrated in FIG. 1, or via other suitable hardware and software.

At step 502, the method 500 includes receiving a query related to a tax operation. As described in detail above, the query may be input during a turn-based dialog session between a user and a tax application virtual assistant program via a chat interface displayed in a graphical user interface (GUI) of a computing device. The user may be a customer or client using a tax application, and the query may be a request to perform a tax-related task, which requires the creation of an artificial intelligence (AI) agent, or a command to create the AI agent to perform the tax-related task.

Continuing from step 502 to step 504, the method 500 includes identifying an intent in the query to generate the new AI agent. An intent processor may be implemented to process the query and identify an intent of the user based on information in the query. The intent processor selects a command associated with the identified intent from a command library. When the user intent is detected as desiring or requiring to create a new AI agent on the tax platform, a create agent command is called.

Proceeding from step 504 to step 506, the method 500 includes selecting a first workflow to create a new workflow to be used in the generation of the new AI agent. The first workflow may be selected from a plurality of workflows in a workflow library. As described in detail above, the first workflow is configured as a create agent workflow.

Advancing from step 506 to step 508, the method 500 may include executing the first workflow to create the new workflow. The create agent workflow is passed to a workflow orchestrator, which is configured to instantiate one or more agents, such as a language model agent and utility agents, to implement the create agent workflow and create the new workflow for the new AI agent. Once created, the new workflow may be displayed in a graphical user interface for human-in-the-loop review. The new workflow may be displayed as a sequence of steps in a table to enable human-in-the-loop editing of the sequence of steps by moving actions, removing actions, editing actions, and adding actions in the sequence.

Continuing from step 508 to step 510, the method 500 may include outputting the new workflow to the workflow library.

Proceeding from step 510 to step 512, the method 500 may include selecting a second workflow to generate the new AI agent based on the new workflow. As with the create agent workflow, the second workflow may be selected from a plurality of workflows in a workflow library. The second workflow is configured as a generate agent workflow that generates the new AI agent.

Advancing from step 512 to step 514, the method 500 may include executing the second workflow to generate the new AI agent.

Continuing from step 514 to step 516, the method 500 may include outputting the new AI agent. When the generation of the new AI agent is invoked by a customer on the tax platform, the new AI agent is stored in a library of customer utility agents. Similarly, when the generation of the new AI agent is invoked by a third party on the tax platform, the new AI agent is stored in a library of third party utility agents. In some implementations, the new AI agent is included in a tax-related AI agent marketplace for use by customers of the tax platform and associated third parties. The AI agent can be executed by an authorized user of the AI agent to perform a tax-related task. Some example tax-related tasks the AI can be configured to perform when executed include preparing tax returns or other filings for tax authorities, calculating tax on a pending transaction, categorizing a good or service as having an effective tax rate, and analyzing data sources like reports for anomalies and insights.

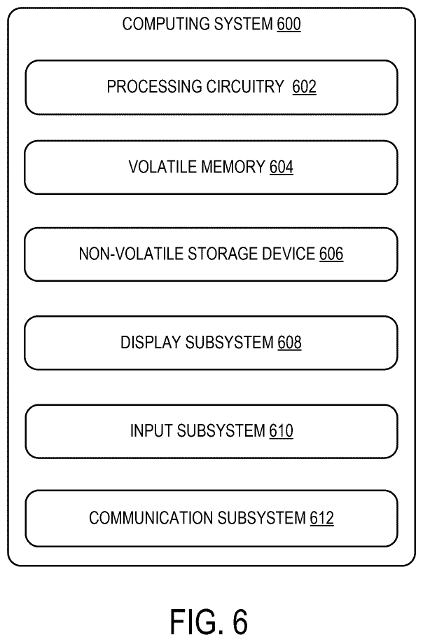

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

The processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional support for the claims of the subject application. One aspect provides computing system for creating an artificial intelligence agent on a tax platform. The computing system may comprise a computing device including processing circuitry configured to execute instructions using portions of associated memory to implement a tax application virtual assistant program. The processing circuitry may be configured to receive a query related to a tax operation via a chat interface in a turn-based dialog session, identify an intent in the query to generate a new artificial intelligence (AI) agent, and implement a workflow selector to select a first workflow from a plurality of workflows in a workflow library. The first workflow may be configured to create a new workflow to be used in the generation of the new AI agent. The processing circuitry may be further configured to instantiate, via a workflow orchestrator, one or more utility agents to execute the first workflow and create the new workflow, output the new workflow to the workflow library, and implement the workflow selector to select a second workflow from the plurality of workflows in the workflow library. The second workflow may be configured to generate the new AI agent based on the new workflow. The processing circuitry may be further configured to instantiate, via the workflow orchestrator, one or more utility agents to execute the second workflow and generate the new AI agent, and output the new AI agent.

In this aspect, additionally or alternatively, prior to outputting the new workflow, the new workflow may be displayed in a graphical user interface for human-in-the-loop review. In this aspect, additionally or alternatively, the new workflow may be displayed as a sequence of steps to thereby enable human-in-the-loop editing of the sequence of steps in the new workflow. In this aspect, additionally or alternatively, human-in-the-loop editing of the sequence of workflow steps may include at least one of moving actions, removing actions, editing actions, and adding actions in the sequence. In this aspect, additionally or alternatively, generation of the new AI agent may be invoked by a customer on the tax platform, and the new AI agent is stored in a library of customer utility agents. In this aspect, additionally or alternatively, generation of the new AI agent may be invoked by a third party on the tax platform, and the new AI agent is stored in a library of third party utility agents. In this aspect, additionally or alternatively, the new AI agent may be included in a tax-related AI agent marketplace for use by customers and third parties. In this aspect, additionally or alternatively, the new AI agent may be executed in an interactive execution mode in which each step of the new workflow on which the new AI agent is based is displayed in a graphical user interface as it is performed. In this aspect, additionally or alternatively, the new AI agent may be executed in an autonomous mode based on user-specified schedule conditions. In this aspect, additionally or alternatively, the new AI tax agent may be executed to prepare tax returns or other filings for tax authorities, calculate tax on a pending transaction, categorize a good or service as having an effective tax rate, or analyze data sources for anomalies and insights.

Another aspect provides a method for creating an artificial intelligence agent on a tax platform. The method may comprise receiving a query related to a tax operation via a chat interface in a turn-based dialog session, identifying an intent in the query to generate a new artificial intelligence (AI) agent, and selecting a first workflow from a plurality of workflows in a workflow library. The first workflow may be configured to create a new workflow to be used in the generation of the new AI agent. The method may further comprise executing the first workflow to create the new workflow, outputting the new workflow to the workflow library, and selecting a second workflow from the plurality of workflows in the workflow library. The second workflow may be configured to generate the new AI agent based on the new workflow. The method may further comprise executing the second workflow to generate the new AI agent, and outputting the new AI agent.

In this aspect, additionally or alternatively, the method may further comprise prior to outputting the new workflow, displaying the new workflow in a graphical user interface for human-in-the-loop review. In this aspect, additionally or alternatively, the method may further comprise displaying the new workflow as a sequence of steps in a table to thereby enable human-in-the-loop editing of the sequence of steps in the new workflow. In this aspect, additionally or alternatively, human-in-the-loop editing of the sequence of workflow steps may include at least one of moving actions, removing actions, editing actions, and adding actions in the sequence. In this aspect, additionally or alternatively, generation of the new AI agent may be invoked by a customer on the tax platform, and the method may further comprise storing the new AI agent in a library of customer utility agents. In this aspect, additionally or alternatively, generation of the new AI agent may be invoked by a third party on the tax platform, and the method may further comprise storing the new AI agent in a library of third party utility agents. In this aspect, additionally or alternatively, the method may further comprise including the new AI agent in a tax-related AI agent marketplace for use by customers and third parties. In this aspect, additionally or alternatively, the method may further comprise executing the new AI agent in an interactive execution mode in which each step of the new workflow on which the new AI agent is based is displayed in a graphical user interface as it is performed. In this aspect, additionally or alternatively, the method may further comprise executing the new AI agent in an autonomous mode based on user-specified schedule conditions.

Another aspect provides a computing system for creating an artificial intelligence agent on a tax platform. The computing system may comprise a computing device including processing circuitry configured to execute instructions using portions of associated memory to implement a tax application virtual assistant program. The processing circuitry may be configured to receive a query related to a tax operation via a chat interface in a turn-based dialog session, identify an intent in the query to generate a new artificial intelligence (AI) agent, and implement a workflow selector to select a first workflow from a plurality of workflows in a workflow library.

The first workflow may be configured to create a new workflow to be used in the generation of the new AI agent. The processing circuitry may be further configured to instantiate, via a workflow orchestrator, one or more utility agents to execute the first workflow and create the new workflow, display the new workflow as a sequence of steps in a graphical user interface for human-in-the-loop review, and output the new workflow to the workflow library. The processing circuitry may be further configured to implement the workflow selector to select a second workflow from the plurality of workflows in the workflow library. The second workflow may be configured to generate the new AI agent based on the new workflow. The processing circuitry may be further configured to instantiate, via the workflow orchestrator, one or more utility agents to execute the second workflow and generate the new AI agent, and output the new AI agent. The new AI agent may be included in a tax-related AI agent marketplace on the tax platform for use by customers and third parties.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for creating an artificial intelligence agent on a tax platform, the computing system comprising:
a computing device including processing circuitry configured to execute instructions using portions of associated memory to implement a tax application virtual assistant program, the processing circuitry being configured to:
receive a query related to a tax operation via a chat interface in a turn-based dialog session;
identify an intent in the query to generate a new artificial intelligence (AI) agent;
implement a workflow selector to select a first workflow from a plurality of workflows in a workflow library, the first workflow being configured to create a new workflow to be used in the generation of the new AI agent;
instantiate, via a workflow orchestrator, one or more utility agents to execute the first workflow and create the new workflow;
output the new workflow to the workflow library;
implement the workflow selector to select a second workflow from the plurality of workflows in the workflow library, the second workflow being configured to generate the new AI agent based on the new workflow;
instantiate, via the workflow orchestrator, one or more utility agents to execute the second workflow and generate the new AI agent; and
output the new AI agent.

2. The computing system of claim 1, wherein
prior to outputting the new workflow, the new workflow is displayed in a graphical user interface for human-in-the-loop review.

3. The computing system of claim 2, wherein
the new workflow is displayed as a sequence of steps to thereby enable human-in-the-loop editing of the sequence of steps in the new workflow.

4. The computing system of claim 3, wherein
human-in-the-loop editing of the sequence of workflow steps includes at least one of moving actions, removing actions, editing actions, and adding actions in the sequence.

5. The computing system of claim 1, wherein
generation of the new AI agent is invoked by a customer on the tax platform, and
the new AI agent is stored in a library of customer utility agents.

6. The computing system of claim 1, wherein
generation of the new AI agent is invoked by a third party on the tax platform, and
the new AI agent is stored in a library of third party utility agents.

7. The computing system of claim 1, wherein
the new AI agent is included in a tax-related AI agent marketplace for use by customers and third parties.

8. The computing system of claim 1, wherein
the new AI agent is executed in an interactive execution mode in which each step of the new workflow on which the new AI agent is based is displayed in a graphical user interface as it is performed.

9. The computing system of claim 1, wherein
the new AI agent is executed in an autonomous mode based on user-specified schedule conditions.

10. The computing system of claim 1, wherein
the new AI tax agent is executed to prepare tax returns or other filings for tax authorities, calculate tax on a pending transaction, categorize a good or service as having an effective tax rate, or analyze data sources for anomalies and insights.

11. A method for creating an artificial intelligence agent on a tax platform, the method comprising:
receiving a query related to a tax operation via a chat interface in a turn-based dialog session;
identifying an intent in the query to generate a new artificial intelligence (AI) agent;
selecting a first workflow from a plurality of workflows in a workflow library, the first workflow being configured to create a new workflow to be used in the generation of the new AI agent;
executing the first workflow to create the new workflow;
outputting the new workflow to the workflow library;
selecting a second workflow from the plurality of workflows in the workflow library, the second workflow being configured to generate the new AI agent based on the new workflow;
executing the second workflow to generate the new AI agent; and
outputting the new AI agent.

12. The method of claim 11, the method further comprising:
prior to outputting the new workflow, displaying the new workflow in a graphical user interface for human-in-the-loop review.

13. The method of claim 12, the method further comprising:
displaying the new workflow as a sequence of steps in a table to thereby enable human-in-the-loop editing of the sequence of steps in the new workflow.

14. The method of claim 13, wherein
human-in-the-loop editing of the sequence of workflow steps includes at least one of moving actions, removing actions, editing actions, and adding actions in the sequence.

15. The method of claim 11, wherein
generation of the new AI agent is invoked by a customer on the tax platform, and
the method further comprises storing the new AI agent in a library of customer utility agents.

16. The method of claim 11, wherein
generation of the new AI agent is invoked by a third party on the tax platform, and
the method further comprises storing the new AI agent in a library of third party utility agents.

17. The method of claim 11, the method further comprising:
including the new AI agent in a tax-related AI agent marketplace for use by customers and third parties.

18. The method of claim 11, the method further comprising:
executing the new AI agent in an interactive execution mode in which each step of the new workflow on which the new AI agent is based is displayed in a graphical user interface as it is performed.

19. The method of claim 11, the method further comprising:
executing the new AI agent in an autonomous mode based on user-specified schedule conditions.

20. A computing system for creating an artificial intelligence agent on a tax platform, the computing system comprising:
a computing device including processing circuitry configured to execute instructions using portions of associated memory to implement a tax application virtual assistant program, the processing circuitry being configured to:
receive a query related to a tax operation via a chat interface in a turn-based dialog session;
identify an intent in the query to generate a new artificial intelligence (AI) agent;
implement a workflow selector to select a first workflow from a plurality of workflows in a workflow library, the first workflow being configured to create a new workflow to be used in the generation of the new AI agent;
instantiate, via a workflow orchestrator, one or more utility agents to execute the first workflow and create the new workflow;
display the new workflow as a sequence of steps in a graphical user interface for human-in-the-loop review;
output the new workflow to the workflow library;
implement the workflow selector to select a second workflow from the plurality of workflows in the workflow library, the second workflow being configured to generate the new AI agent based on the new workflow;
instantiate, via the workflow orchestrator, one or more utility agents to execute the second workflow and generate the new AI agent; and
output the new AI agent, wherein
the new AI agent is included in a tax-related AI agent marketplace on the tax platform for use by customers and third parties.
